(19) United States
(12) Patent Application Publication
(10) Pub. No.: US 2013/0166733 A1
(43) Pub. Date: Jun. 27, 2013

(54) NETWORK BANDWIDTH DISTRIBUTION DEVICE AND METHOD THEREOF

(71) Applicants: Kyoung-Soon KANG, Daejeon (KR); Hak Suh KIM, Daejeon (KR); Ki Cheol JEON, Daejeon (KR); Hyeonsik YOON, Daejeon (KR); Boo Geum JUNG, Daejeon (KR); Hea Sook PARK, Daejeon (KR)

(72) Inventors: Kyoung-Soon KANG, Daejeon (KR); Hak Suh KIM, Daejeon (KR); Ki Cheol JEON, Daejeon (KR); Hyeonsik YOON, Daejeon (KR); Boo Geum JUNG, Daejeon (KR); Hea Sook PARK, Daejeon (KR)

(73) Assignee: Electronics and Telecommunications Research Institute, Daejeon (KR)

(21) Appl. No.: 13/619,913

(22) Filed: Sep. 14, 2012

(30) Foreign Application Priority Data
Dec. 27, 2011 (KR) 10-2011-0143143

(51) Int. Cl. G06F 15/173

(52) U.S. Cl. 709/224

(57) ABSTRACT

Disclosed is a network bandwidth distribution device which includes an information collector which collects information associated with a connection environment; a controller which judges a state of a connection environment according to the collected information and collects information of each user to judge whether an occupied bandwidth of each user is exceeded; and a bandwidth allotter which limits an occupied bandwidth of each user based on the judged state of a connection environment and whether an occupied bandwidth of each user is exceeded.

### CROSS-REFERENCE TO RELATED APPLICATIONS

A claim for priority under 35 U.S.C. §119 is made to Korean Patent Application No. 10-2011-0143143 filed Dec. 27, 2011, in the Korean Intellectual Property Office, the entire contents of which are hereby incorporated by reference.

### BACKGROUND

The inventive concepts described herein relate to a network bandwidth distribution device and method.

A router may be a device which relays information flow between networks. The router may receive a packet transmitted from a source. The router may select an optimum path to send the input packet to a destination through the selected path. In a packet switching network, it may be difficult for a server and a client to authorize a priority on a network resource in itself. Thus, the router may distribute a network resource request between the server and the client.

As a Pear-to-Pear (P2P) service is developed, in recent years, the phenomenon that traffic is excessively focused on a specific user may arise. Since a network resource provided by the router is limited, a minimum bandwidth may be provided to a user to be connected later due to excessive focusing of the traffic on the specific user. That is, a difference of quality of service may be generated between users. This problem may be solved by a method of generating a profile on an individual user to provide the quality of service (QoS). However, this manner may necessitate a many maintenance cost.

### SUMMARY

Example embodiments of the inventive concept provide a network bandwidth distribution device comprising an information collector which collects information associated with a connection environment; a controller which judges a state of a connection environment according to the collected information and collects information of each user to judge whether an occupied bandwidth of each user is exceeded; and a bandwidth allotter which limits an occupied bandwidth of each user based on the judged state of a connection environment and whether an occupied bandwidth of each user is exceeded.

In example embodiments, the judged state of a connection environment includes an exceeding state and a danger state of a connection environment.

In example embodiments, the exceeding state of the connection environment is judged by comparing a currently connected user number with a predetermined maximum user number.

In example embodiments, the danger state of the connection environment is judged by comparing the currently connected user number with a predetermined normal user number.

In example embodiments, the exceeding state of the connection environment is judged by comparing the whole occupied bandwidth with a predetermined maximum bandwidth.

In example embodiments, the danger state of the connection environment is judged by comparing the whole occupied bandwidth with a predetermined normal bandwidth.

In example embodiments, whether an occupied bandwidth of each user is exceeded is judged by comparing a calculated theoretical bandwidth and an occupied bandwidth of each user.

In example embodiments, the theoretical bandwidth is calculated on the basis of a predetermined normal bandwidth and a currently connected user number.

In example embodiments, the theoretical bandwidth is calculated on the basis of the whole occupied bandwidth and a currently connected user number.

Example embodiments of the inventive concept provide a network bandwidth distribution method comprising judging whether a connection environment is at an exceeding state; when the connection environment is not at an exceeding state, judging whether the connection environment is at a danger state; calculating a theoretical bandwidth when the connection environment is at a danger state; and limiting an occupied bandwidth of a user having an occupied bandwidth larger than a theoretical bandwidth.

In example embodiments, the theoretical bandwidth is calculated on the basis of a predetermined normal bandwidth and a currently connected user number.

In example embodiments, the theoretical bandwidth is calculated on the basis of the whole occupied bandwidth and a currently connected user number.

In example embodiments, the judging whether a connection environment is at an exceeding state comprises measuring the whole user number and the whole occupied bandwidth; comparing the whole user number with a predetermined maximum user number; and comparing the whole occupied bandwidth with a predetermined maximum bandwidth.

In example embodiments, the judging whether the connection environment is at a danger state comprises comparing the whole user number with a predetermined normal user number; and comparing the whole occupied bandwidth with a predetermined normal bandwidth.

In example embodiments, the limiting an occupied bandwidth of a user having an occupied bandwidth larger than a theoretical bandwidth is released when a predetermined time elapses.

### BRIEF DESCRIPTION OF THE FIGURES

The above and other objects and features will become apparent from the following description with reference to the following figures, wherein like reference numerals refer to like parts throughout the various figures unless otherwise specified, and wherein

FIG. 1 is a block diagram schematically illustrating a network bandwidth distribution device according to an embodiment of the inventive concept.

FIG. 2 is a diagram illustrating constitution of information associated with a user.

FIG. 3 is a flowchart illustrating a network bandwidth distribution method according to an embodiment of the inventive concept.

FIG. 4 is a flowchart illustrating a network bandwidth distribution method according to another embodiment of the inventive concept.

### DETAILED DESCRIPTION

Embodiments will be described in detail with reference to the accompanying drawings. The inventive concept, however, may be embodied in various different forms, and should not be construed as being limited only to the illustrated embodiments. Rather, these embodiments are provided as examples so that this disclosure will be thorough and complete, and will fully convey the concept of the inventive concept to those skilled in the art. Accordingly, known processes, elements, and techniques are not described with respect to some of the embodiments of the inventive concept. Unless otherwise noted, like reference numerals denote like elements throughout the attached drawings and written description, and thus descriptions will not be repeated. In the drawings, the sizes and relative sizes of layers and regions may be exaggerated for clarity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Also, the term “exemplary” is intended to refer to an example or illustration.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

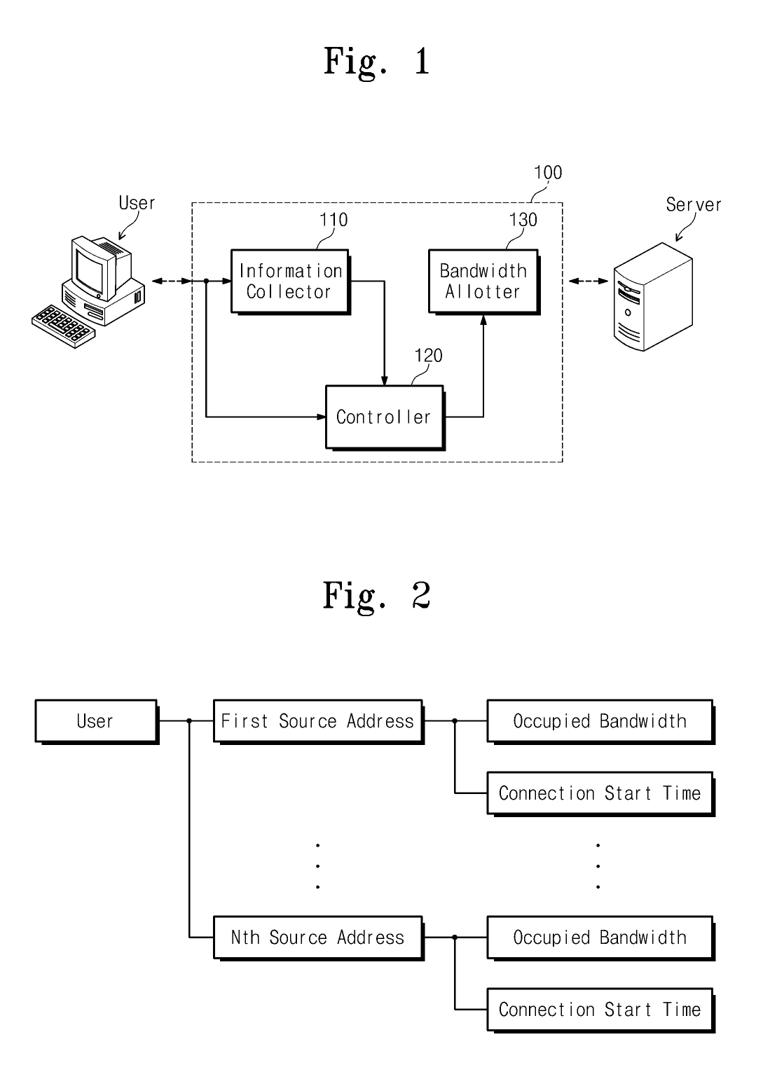

FIG. 1 is a block diagram schematically illustrating a network bandwidth distribution device according to an embodiment of the inventive concept. Referring to FIG. 1, a network bandwidth distribution device 100 may include an information collector 110, a controller 120, and a bandwidth allotter 130.

The network bandwidth distribution device 100 may be connected with a plurality of users and a plurality of servers. In example embodiments, there is illustrated the case that the network bandwidth distribution device 100 is connected with a user and a server. However, the inventive concept is not limited thereto. For example, the network bandwidth distribution device 100 may two or more users and two or more servers. The network bandwidth distribution device 100 may be included within a router. The router may be a device which relays different communication networks.

The network bandwidth distribution device 100 may receive a flow from a connected user. The user may be an unauthorized external network. For example, the user may be a virtual private network (VPN) server, a local area network (LAN) client, or the like. A protocol of the flow generated by the user may not be limited. For example, the user may generate a flow using a TCP protocol. The flow may include information such as an internet protocol address and a port of a source, an internet protocol address and a port of a destination, and a protocol.

The network bandwidth distribution device 100 may send a flow input from the user to a destination server. There may be limited a bandwidth of the network bandwidth distribution device 100 which is used when a flow is passed. Thus, in the event that a plurality of users is connected, the network bandwidth distribution device 100 may actively distribute a bandwidth on each user to use a limited bandwidth efficiently.

The information collector 110 may collect information associated with a connection environment of the network bandwidth distribution device 100. The information collector 110 may calculate the number of users connected with the network bandwidth distribution device 100. Also, the information collector 110 may calculate a bandwidth which is currently occupied by the network bandwidth distribution device 100. The information collector 110 may transfer the collected information to the controller 120.

The controller 120 may judge an exceeding level of a connection environment of the network bandwidth distribution device 100. When the number of users currently connected with the network bandwidth distribution device 100 exceeds a predetermined maximum user number, the controller 120 may judge the connection environment to be at an exceeding level.

When the connection environment is judged to be at a danger level, the controller 120 may collect information associated with each user.

When the number of users currently connected with the network bandwidth distribution device 100 exceeds a predetermined normal user number, the controller 120 may judge the connection environment to be at a danger level. Information of each user collected by the collector 120 may include a connection start time and an occupied bandwidth of a user. The occupied bandwidth of a user may be an average value during a connection time of the user.

The controller 120 may calculate a theoretical bandwidth based on a predetermined normal bandwidth and the number of users currently connected. The theoretical bandwidth may be an average bandwidth which the network bandwidth distribution device 100 theoretically provides to each user to correspond to the number of users currently connected. The theoretical bandwidth may be calculated by dividing a normal bandwidth by a value of (CCUN+1) (CCUN being the number of users currently connected). Alternatively, the theoretical bandwidth may be calculated by dividing a currently occupied bandwidth by a value of (CCUN+1) (CCUN being the number of users currently connected). However, the inventive concept is not limited thereto. The controller 120 may judge a user which has an occupied bandwidth larger than the theoretical bandwidth. The controller 120 may provide the bandwidth allotter 130 with a state of the judged connection environment and information of a user having an occupied bandwidth larger than the theoretical bandwidth.

The bandwidth allotter 130 may drop a flow of a new user when a connection environment of the network bandwidth distribution device 100 is judged to be at an exceeding level. Dropping of a flow on the new user may be maintained until connection of a previous user is ended and a connection environment of the network bandwidth distribution device 100 judged by the controller 120 gets out of the exceeding level.

When a connection environment of the network bandwidth distribution device 100 is judged to be at an exceeding level, the bandwidth allotter 130 may limit an occupied bandwidth of a user, which has an occupied bandwidth larger than the theoretical bandwidth, to the theoretical bandwidth. When connection of a user the occupied bandwidth of which is limited is ended or when a predetermined time elapses, the controller 120 may release limit on the occupied bandwidth.

With the above description, the network bandwidth distribution device 100 may fairly distribute a network actively to correspond to the number of users connected. Thus, it is possible to provide the same quality of service to all connected users regardless of a connection time of a user. Also, it is possible to prevent a bandwidth from being focused on a specific user. As a result, a network bandwidth maintenance cost may be reduced.

FIG. 2 is a diagram illustrating constitution of information associated with a user. Referring to FIG. 2, a user may have one or more source addresses, each of which includes information associated with an occupied bandwidth and a connection start time. A controller 120 may group information associated with an occupied bandwidth and a connection start time according to a user to comprehend the grouped information on each user.

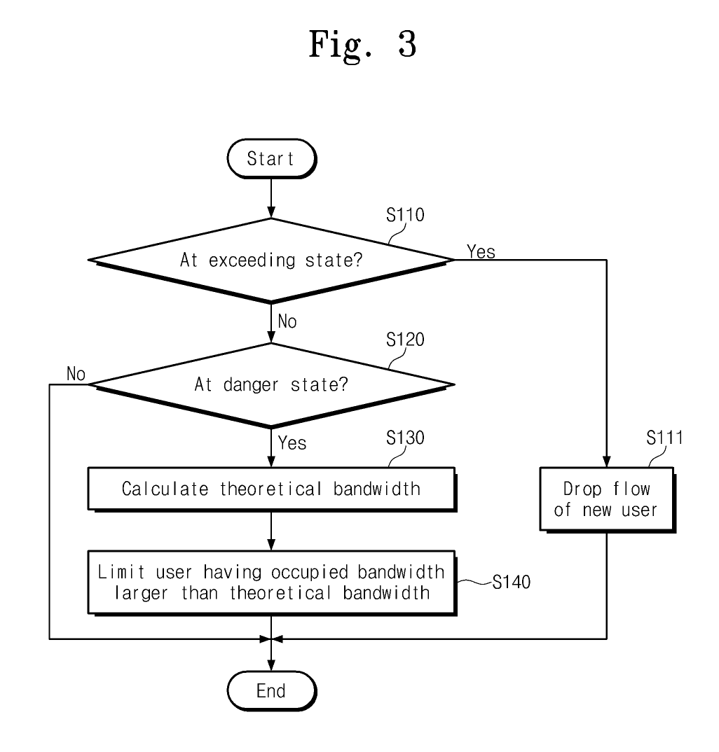

FIG. 3 is a flowchart illustrating a network bandwidth distribution method according to an embodiment of the inventive concept. Referring to FIG. 3, in operation S110, there may be judged an exceeding level of a current connection environment. If the current connection environment is judged to be at an exceeding level, in operation S111, a flow of a new user may be dropped. If the current connection environment is judged not to be at an exceeding level, in operation S120, a danger level of the connection environment may be judged. If the connection environment is judged not to be at a danger level, an occupied bandwidth of each user may not be limited.

If the connection environment is judged to be at a danger level, in operation S130, a theoretical bandwidth may be calculated on the basis of a predetermined normal bandwidth and the number of users currently connected.

The theoretical bandwidth may be an average bandwidth which a network bandwidth distribution device 100 theoretically provides to each user to correspond to the number of users currently connected. The theoretical bandwidth may be calculated by dividing a normal bandwidth by a value of (CCUN+1) (CCUN being the number of users currently connected). However, the inventive concept is not limited thereto.

In operation S140, there may be limited an occupied bandwidth of a user which has a theoretical bandwidth larger than the occupied bandwidth. The occupied bandwidth can be limited to the theoretical bandwidth. When connection of a user the occupied bandwidth of which is limited is ended or when a predetermined time elapses, limit on the occupied bandwidth may be released.

With the above description, the network bandwidth distribution method may fairly distribute a network actively to correspond to the number of users connected. Thus, it is possible to provide the same quality of service to all connected users regardless of a connection time of a user. Also, it is possible to prevent a bandwidth from being focused on a specific user.

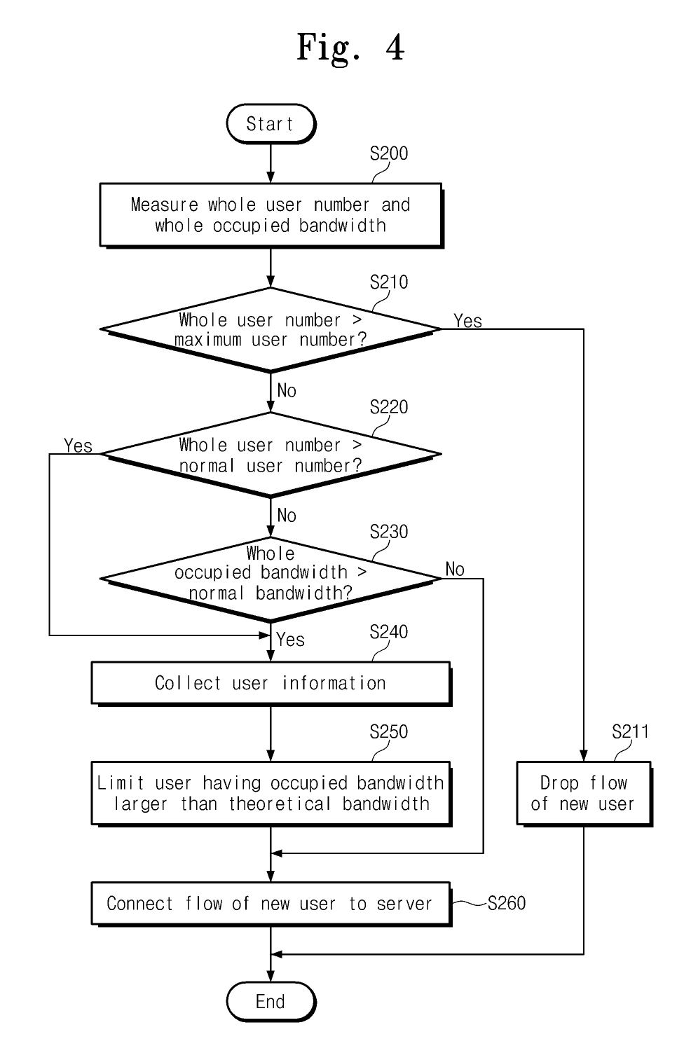

FIG. 4 is a flowchart illustrating a network bandwidth distribution method according to another embodiment of the inventive concept. Referring to FIG. 4, S200, the whole number of users currently connected and the whole occupied bandwidth may be measured. In operation S210, there may be judged whether the whole user number exceeds a predetermined maximum user number. When the whole user number exceeds the maximum user number, in operation S211, a flow of a new user may be dropped.

When the whole user number is below the maximum user number, in operation S220, whether the whole user number exceeds a normal user number may be judged. When the whole user number is below the normal user number, in operation S230, whether the whole user number exceeds a normal bandwidth may be judged. When the whole user number exceeds the normal user number or when the whole occupied bandwidth exceeds the normal bandwidth, in operation S240, information on each user may be collected. A theoretical bandwidth may be calculated on the basis of the collected information. In operation S250, a bandwidth of a user having an occupied bandwidth larger than a theoretical bandwidth may be limited. In operation S260, a flow of the new user may be connected to a server as the limited bandwidth is maintained.

With the above description, the network bandwidth distribution method may judge a state of a connection environment according to the number of connected users. A network may be fairly distributed actively according to the judged state. Thus, it is possible to provide the same quality of service to all connected users regardless of a connection time of a user. Also, it is possible to prevent a bandwidth from being focused on a specific user by uniformly distributing a bandwidth according to a calculated theoretical bandwidth.

Below, a network bandwidth distribution method of the inventive concept will be more fully described. In a connection environment, it is assumed that a maximum connectable user number is 8 and a normal connect number being a connection number to be expected normally is 4. Also, it is assumed that a maximum usable bandwidth is 80 Mbps and a normal bandwidth being an occupied bandwidth to be expected normally is 40 Mbps.

It is assumed that a first user is connected and provided with a bandwidth of 10 Mbps. In this case, since the whole user number is 1 and the whole occupied bandwidth is 10 Mbps, a connection environment may be at a normal state. Thus, no bandwidth may be limited.

It is assumed that a second user is connected and provided with a bandwidth of 10 Mbps. In this case, since the whole user number is 2 and the whole occupied bandwidth is 20 Mbps, a connection environment may be at a normal state. Thus, no bandwidth may be limited.

It is assumed that a third user is connected and provided with a bandwidth of 15 Mbps. In this case, since the whole user number is 3 and the whole occupied bandwidth is 35 Mbps, a connection environment may be at a normal state. Thus, no bandwidth may be limited.

It is assumed that a fourth user is connected and provided with a bandwidth of 20 Mbps. In this case, the whole user number is 4 and the whole occupied bandwidth is 55 Mbps. Since the whole occupied bandwidth exceeds 40 Mbps being a normal bandwidth, a connection environment may be at a danger state.

In example embodiments, it is assumed that a theoretical bandwidth is obtained by dividing a currently occupied bandwidth by a value of (CCUN+1) (CCUN being the number of users currently connected). The theoretical bandwidth may be 11 Mbps obtained by dividing 55 Mbps being the whole occupied bandwidth by 5 being a value of (CCUN+1). Thus, the occupied bandwidth of each of the third and fourth users having the occupied bandwidth exceeding 11 Mbps may be limited to 11 Mbps.

It is assumed that a fifth user is connected and provided with a bandwidth of 10 Mbps under the above-described condition. In this case, the whole user number is 5 and the whole occupied bandwidth is 52 Mbps. Since the whole user number exceeds 4 being a normal user number and the whole occupied bandwidth exceeds 40 Mbps being a normal bandwidth, a connection environment may be at a danger state.

The theoretical bandwidth may become 8.6 Mbps obtained by dividing 52 Mbps being the whole occupied bandwidth by 6 being a value of (CCUN+1). Thus, the occupied bandwidths of all users may be limited to 8.6 Mbps being the theoretical bandwidth. When connection of a user the occupied bandwidth of which is limited is ended or when a predetermined time elapses, limit on the occupied bandwidth may be released.

Although the number of connected users increase, it is possible to provide the same quality of service to all connected users. Also, it is possible to prevent a bandwidth from being focused on a specific user. As a result, a network bandwidth maintenance cost may be reduced.

The inventive concept may be modified or changed variously. For example, an information collector, a controller, and a bandwidth allotter may be changed or modified variously according to environment and use.

While the inventive concept has been described with reference to exemplary embodiments, it will be apparent to those skilled in the art that various changes and modifications may be made without departing from the spirit and scope of the present invention. Therefore, it should be understood that the above embodiments are not limiting, but illustrative.

What is claimed is:

1. A network bandwidth distribution device comprising:
an information collector which collects information associated with a connection environment;
a controller which judges a state of a connection environment according to the collected information and collects information of each user to judge whether an occupied bandwidth of each user is exceeded; and
a bandwidth allotter which limits an occupied bandwidth of each user based on the judged state of a connection environment and whether an occupied bandwidth of each user is exceeded.

2. The network bandwidth distribution device of claim 1, wherein the judged state of a connection environment includes an exceeding state and a danger state of a connection environment.

3. The network bandwidth distribution device of claim 2, wherein the exceeding state of the connection environment is judged by comparing a currently connected user number with a predetermined maximum user number.

4. The network bandwidth distribution device of claim 3, wherein the danger state of the connection environment is judged by comparing the currently connected user number with a predetermined normal user number.

5. The network bandwidth distribution device of claim 2, wherein the exceeding state of the connection environment is judged by comparing the whole occupied bandwidth with a predetermined maximum bandwidth.

6. The network bandwidth distribution device of claim 5, wherein the danger state of the connection environment is judged by comparing the whole occupied bandwidth with a predetermined normal bandwidth.

7. The network bandwidth distribution device of claim 1, wherein whether an occupied bandwidth of each user is exceeded is judged by comparing a calculated theoretical bandwidth and an occupied bandwidth of each user.

8. The network bandwidth distribution device of claim 7, wherein the theoretical bandwidth is calculated on the basis of a predetermined normal bandwidth and a currently connected user number.

9. The network bandwidth distribution device of claim 7, wherein the theoretical bandwidth is calculated on the basis of the whole occupied bandwidth and a currently connected user number.

10. A network bandwidth distribution method comprising:
judging whether a connection environment is at an exceeding state;
when the connection environment is not at an exceeding state, judging whether the connection environment is at a danger state;
calculating a theoretical bandwidth when the connection environment is at a danger state; and
limiting an occupied bandwidth of a user having an occupied bandwidth larger than a theoretical bandwidth.

11. The network bandwidth distribution method of claim 10, wherein the theoretical bandwidth is calculated on the basis of a predetermined normal bandwidth and a currently connected user number.

12. The network bandwidth distribution method of claim 10, wherein the theoretical bandwidth is calculated on the basis of the whole occupied bandwidth and a currently connected user number.

13. The network bandwidth distribution method of claim 10, wherein the judging whether a connection environment is at an exceeding state comprises:
measuring the whole user number and the whole occupied bandwidth;
comparing the whole user number with a predetermined maximum user number; and
comparing the whole occupied bandwidth with a predetermined maximum bandwidth.

14. The network bandwidth distribution method of claim 13, wherein the judging whether the connection environment is at a danger state comprises:
comparing the whole user number with a predetermined normal user number; and
comparing the whole occupied bandwidth with a predetermined normal bandwidth.

15. The network bandwidth distribution method of claim 10, wherein the limiting an occupied bandwidth of a user having an occupied bandwidth larger than a theoretical bandwidth is released when a predetermined time elapses.
